(19) United States
(12) Patent Application Publication
(10) Pub. No.: US 2020/0003008 A1
(43) Pub. Date: Jan. 2, 2020

(54) LADDER SYSTEM FOR TRENCH SHORING

(71) Applicant: Klaus Stewering GmbH & Co. KG, Borken (DE)

(72) Inventors: Theo Heitkamp, Borken (DE); Bernd Schmeinck, Rhede (DE)

(73) Assignee: Klaus Stewering GmbH & Co. KG, Borken (DE)

(21) Appl. No.: 16/490,667

(22) PCT Filed: Mar. 6, 2018
(86) PCT No.: PCT/EP2018/055391

§ 371 Date: Sep. 3, 2019

(30) Foreign Application Priority Data
Mar. 15, 2017 (DE) 10 2017 105 567.3

(51) Int. Cl. E06C 1/02; E06C 7/18; E06C 1/04; E06C 1/12; E06C 1/34; E06C 1/39; E06C 7/16

(52) U.S. Cl. CPC E06C 1/02; E06C 7/181; E06C 7/182; E06C 1/04; E06C 1/36; E06C 1/34; E06C 1/39; E06C 7/16; E06C 7/185; E06C 1/12

(57) ABSTRACT

The invention relates to a ladder system for trench shoring, comprising a lower ladder (14) which extends from the bottom of a trench over a lower subportion (T1) of the height of the trench, and an upper ladder (16) which extends over an upper subportion (T2) of the height of the trench up to a trench edge, wherein the upper ladder (16) is a suspension ladder for suspending onto a shoring panel (12). A ladder system according to the invention is intended to increase the safety of the workers particularly for deep trenches. In a ladder system according to the invention, a platform (22) is arranged at the lower end of the upper ladder (16) is, and that the lower ladder (14) is a stepladder or leaning ladder which stands on the bottom of the trench.

### TECHNICAL FIELD

The system described herein relates to a ladder system for trench shoring, and to the use of such a ladder system for trench shoring.

### BACKGROUND OF THE INVENTION

Trenches having large trench depths are frequently used in the field of civil engineering. The trench walls are supported by lateral shoring panels. The shoring panels are kept at a distance apart by bracing systems. Modern shoring systems allow trench depths of above 5 m, even of above 8 m or above 10 m. A plurality of ladder systems are known in order to allow workers to climb down to the bottom of a shored trench.

U.S. Pat. No. 9,004,227 B2 discloses a climb-in system for a ladder for use in trench construction. The climb-in system has an access platform which lies on the ground outside the trench and is fastened to the upper edge of a shoring panel. The ladder is leaned against a ladder support such that a worker can climb laterally from the platform onto the ladder. The platform and the ladder can be connected.

KR 2016 0044 749 A discloses a fastening system for releasably fastening a ladder to a movable platform. The height of the platform can thus be varied and a ladder of precisely tailored length can be suspended thereon as required.

U.S. Pat. No. 6,907,957 B1 closes a ladder for trench shoring that is suspended on an upper edge of a shoring panel. At its upper end, the ladder has a platform via which a worker can climb into the vertically extending rung region of the ladder. The ladder can be extended as required and thus adapted to a varying trench depth by virtue of an extension piece being suspended onto one of the lower rungs.

It may be desirable to provide a ladder system for trench shoring that is easy to handle and ensures a high degree of safety for workers, particularly in the case of deep trenches.

### SUMMARY OF THE INVENTION

Described herein is a ladder system for trench shoring, which may be easy to handle and ensure a high degree of safety for workers, particularly in the case of deep trenches.

A ladder system according to an embodiment of the system described herein for trench shoring may comprise a lower ladder which may extend from the bottom of a trench over a lower sub-portion of the height of the trench, and an upper ladder which may extend over an upper sub-portion of the height of the trench up to a trench edge. The upper ladder may be a suspension ladder for suspending onto the upper edge of a shoring panel. A platform may be arranged at the lower end of the upper ladder. The lower ladder may be a stepladder or leaning ladder which stands on the bottom of the trench.

The overall height of the trench thus may be overcome by means of two ladders. The safety of the construction workers, in particular with regard to falls, may be improved in the ladder system according to an embodiment of the system described herein by virtue of the fact that the maximum fall height, i.e. the maximum height down to an underlying horizontal surface, may be limited. For the upper ladder, the maximum fall height may be limited by the platform arranged at the lower end of the upper ladder. For the lower ladder, the fall height may be limited by the bottom of the trench. Here, the two ladders each may have a height or length of considerably less than 10 m, and may be less than 8 m and may even be at most 6 m.

A suspension ladder may be positioned at the upper edge of the trench in a secure and simple manner. For this purpose, the suspension ladder may have hooks for suspending in the upper edge of a shoring panel. Such a connection allows the upper ladder to be displaced, and thus positioned, along the upper edge of the shoring panel. A stepladder or a leaning ladder which stands on the bottom of the trench offers the advantage that it may be acquired in a cost-effective manner and as a standard accessory and does not require any special production. What may be particularly suitable as a lower ladder is a leaning ladder which may extend obliquely to a trench wall or shoring panel and at the same time may be supported by its upper end on the trench wall or the shoring panel. Such a leaning ladder may be used in a space-saving manner and, together with the upper suspension ladder, form a flexible ladder system which may be easily positioned. The leaning ladder may be set up quickly at any desired point on the bottom of the trench.

The ladder system according to an embodiment of the system described herein may be positioned flexibly and as required in any desired region of a trench. In particular, the ladder system may not be a fixedly installed system which is permanently connected to a wall or a structure, but rather may be a system that may be easily moved and may be quickly mounted.

For trenches which are deeper than 12 m, it should be pointed out that a ladder system having more than two ladders also may be used, in which case the ladders likewise each may extend over a sub-portion of the trench. Here, platforms which limit the maximum fall height of the respective upper ladder may be provided on all upper ladders, i.e., on all the ladders apart from the lowermost ladder. In an embodiment, the shoring panels may be stepped in various shoring systems, an outer shoring panel may delimit the upper trench portion and an inner shoring panel may delimit the lower trench portion. In such an embodiment, the first upper ladder may be suspended at the upper edge of the outer shoring panel, and the second upper ladder may be suspended at the upper edge of the inner shoring panel. The lowermost ladder again may stand on the trench bottom.

In an embodiment, the platform at the lower end of the upper ladder may have a flap through which a worker may climb. In this case, the upper ladder and the lower ladder may be arranged exactly one below the other.

As alternative thereto, the lower ladder and the upper ladder may be arranged so as to be laterally offset to one another, in which case the lower ladder and the upper ladder may extend next to one another in an overlap region. In the case of such a laterally offset arrangement, the overlap region may serve as a transfer region in which a worker may transfer from one ladder to the other ladder. The transfer region may be configured in such a way that a worker who is standing at the level of the platform may step over laterally from one ladder to the other ladder and may at the same time in each case hold on firmly to one of the two ladders with an upright body posture. In particular, the transfer region may extend over a height of at least 60 cm, and may be over a height of at least 80 cm, and may be even over a height of at least 100 cm.

In an embodiment, the upper ladder and/or the lower ladder may be height-adjustable. The ladder system thus may be flexibly adapted to different depths, in particular to depths of the trench which change during the construction work. Here, ladders having a telescopic pull-out particularly come into consideration. As alternative thereto, it also may be possible for different ladders with different lengths to be used.

In an embodiment, a system having a suspension ladder and a leaning ladder may be particularly suitable.

It thus may be possible in a simple manner to achieve a high degree of flexibility with respect to the position of the ladder system in the trench and to achieve a quick set-up and removal of the ladder system according to embodiments of the system described herein.

In order to increase the safety of the workers, the platform at the lower end of the upper ladder may be secured by a peripheral railing. A railing particularly may have the effect that a worker may be secured against falling down from the platform, in particular when he or she transfers from one ladder to the other ladder. Here, a railing may be arranged at a height of at least 90 cm from the platform.

Furthermore, supporting feet which extend transversely to the vertical direction and which are supported against the trench wall may be arranged at the lower end of the upper ladder. In particular, the supporting feet may be variable in their length. It thus may be possible for the upper ladder to be supported in dependence on the thickness of a shoring panel or the distance of the upper ladder from the shoring panel or a trench wall and thus to be oriented completely vertically, i.e., without overhang. As a result, the safety of the workers may be additionally increased, and swinging of the ladder, as is known for example from rope ladders, may be avoided.

In practice, a climb-in aid may be arranged on the upper ladder. A climb-in aid allows a safe transition from the ground situated outside the trench to the vertically oriented ladder. The climb-in aid may be, for example, a hand rail which may be arranged on one side or on both sides of the ladder and to which a worker may firmly hold on.

In addition, there may be arranged on the upper ladder one or more back protection bows which surround the upper ladder, in particular in an upper region in the direction of the trench, in the form of a U or of a ring segment.

In particular, a climb-in aid may be provided in conjunction with a back protection bow. For this purpose, a back protection bow which may be adjusted in terms of height may be arranged at the upper end of the upper ladder. The back protection bow may be provided with two struts which may be arranged laterally of the upper ladder and which each form a hand rail. The struts may be fastened to a side part of the upper ladder such that they may be pulled out and arrested, with the result that the height of the uppermost back protection bow may be adjusted above the upper ladder end. The adjustment may be able to be realized, for example, by a lever which may be actuated by means of the foot and which securely clamps the strut at the desired height. This adjusting device may be easy and safe to operate. The arrangement of a height-adjustable back protection bow in the region of the climb-in may further increase the safety of the workers. It should be appreciated that a plurality of back protection bows also may be fastened height-adjustably by the lateral struts.

In order to further increase safety, in an embodiment the lower ladder and the upper ladder may be connected via a securing element. Slipping of the lower ladder relative to the upper ladder thus may be counteracted. Such a securing element may comprise two corresponding hooks. As alternative or in addition thereto, the lower ladder may be fastened to the upper ladder by means of screw clamps, or the two ladders may be secured via a chain, rope or cable.

The system described herein also relates to the use of a ladder system for trench shoring as described above. The use of the ladder system according to embodiments of the system described herein allows a safe and flexible option for workers to access a trench.

### BRIEF DESCRIPTION OF THE DRAWINGS

Further embodiments and advantages of the system described herein are described below in conjunction with the drawings, in which:

FIG. 1 shows a ladder system, according to an embodiment of the system described herein, with a first variant of an upper ladder and a lower ladder in a front view;

FIG. 2 shows the ladder system from FIG. 1 in a side view, according to an embodiment of the system described herein;

FIG. 3 shows the ladder system from FIG. 1 in a view from above, according to an embodiment of the system described herein; and

FIG. 4 shows a second variant of an upper ladder in a perspective view obliquely from the front, according to an embodiment of the system described herein.

### DESCRIPTION OF VARIOUS EMBODIMENTS

Illustrative embodiments of the system described herein will now be described in relation to the drawings. It should be appreciated that the system described herein is not limited to the following illustrative embodiments, as other embodiments, for example, variations of the following illustrative embodiments, are possible, and intended to fall within the scope of the invention.

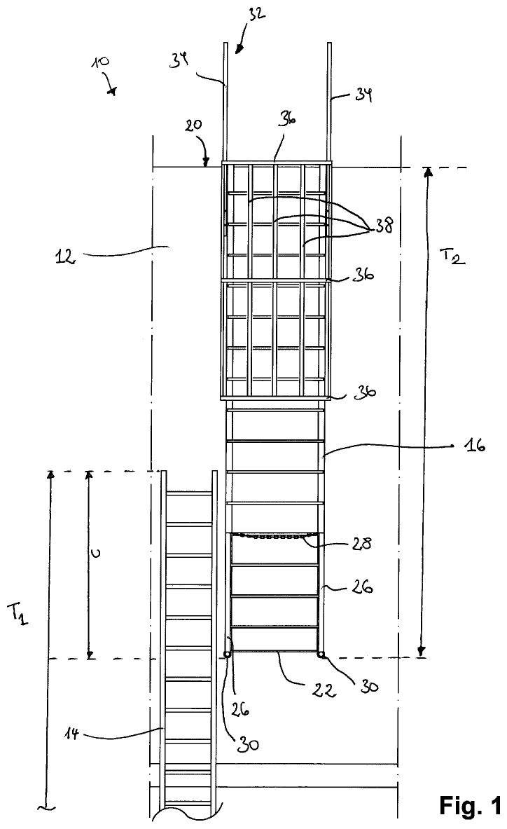

FIGS. 1 to 3 each illustrate a ladder system 10 according to the system described herein in conjunction with a shoring panel 12. Only one wall of the trench is illustrated in these figures. The shoring panel 12 forms the trench wall and may serve for supporting the ground situated laterally of the trench. In the present case, it may extend over a part of the height of the trench and a part of the width of the trench.

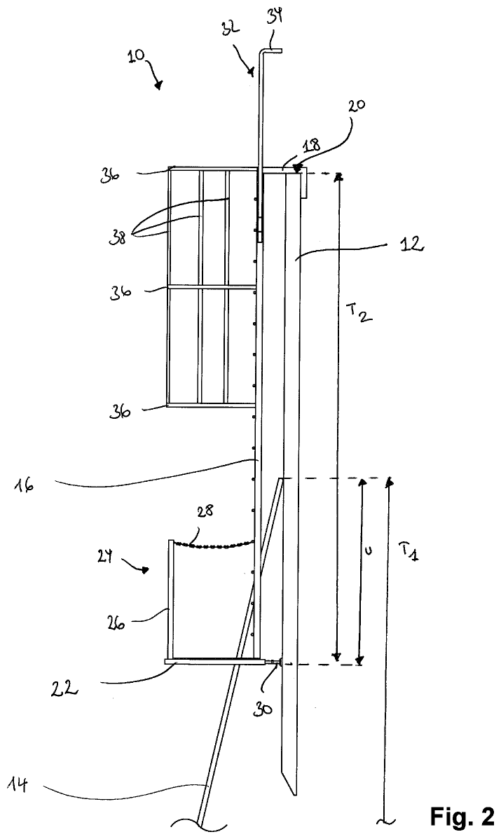

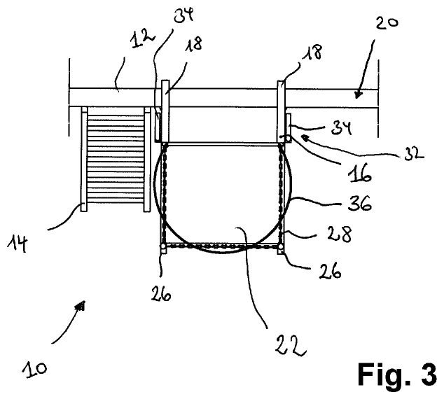

FIG. 1 illustrates a ladder system 10 according to the system described herein in a front view. The front view of the ladder system 10 situated in the trench corresponds to a view of a side wall of the trench or of the shoring panel 12. The view shown in FIG. 2 accordingly corresponds to a view transversely to the shoring panel 12 in the longitudinal direction of the trench. FIG. 3 shows a view from above in the direction of the bottom of the trench.

The ladder system 10 may comprise a lower ladder 14 which may be supported on a bottom of the trench (not shown) and which may extend over a lower sub-portion T₁ of the height of the trench. In addition, the ladder system 10 may comprise a first variant of an upper ladder 16 which may extend over an upper sub-portion T₂ of the height of the trench up to an upper trench edge. In the present case, the upper edge of the trench corresponds to the upper edge 20 of the shoring panel 12. The upper ladder 16 and the lower ladder 14 may be arranged so as to be laterally offset to one another (cf. also FIG. 3). As is clearly evident from FIGS. 1 and 2, the upper ladder 16 and the lower ladder 14 may extend next to one another in an overlap region U.

In the example shown, the lower ladder 14 may be a leaning ladder which stands by its lower end on the bottom of the trench (not shown) and may be supported by its upper end on the front side of the shoring panel 12. The lower ladder 14 may be arranged at an angle to the shoring panel 12 in order to allow a worker to climb up and down in as simple a manner as possible. The maximum fall height of the lower ladder 14 may be limited to the sub-portion T₁.

In the present case, the upper ladder 16 may be configured as a suspension ladder. For this purpose, the upper ladder 16 may have at its upper end two hooks 18 by means of which the upper ladder 16 may be suspended onto the upper edge 20 of the shoring panel 12. For this purpose, the hooks 18 may engage around the shoring panel 12 and may bear both against the upper side and against the rear side of the shoring panel 12.

A platform 22 which may extend horizontally may be arranged at the lower end of the upper ladder 16. The platform 22 may serve as a lower boundary of the upper ladder 16 and limit the maximum fall height to the sub-portion T₂. The platform 22 may be secured by a peripheral railing 24. In the present case, the railing 24 may be formed by two vertical struts 26 at the corners of the platform 22 and a chain 28 which connects the vertical struts 26 to the upper ladder 16. In an embodiment, the maximum fall heights T₁ and T₂ may be at most 6 m, and may be less than 4 m.

Said overlap region U may serve for the transfer of a worker from one ladder to the other ladder. Here, the overlap region U may be realized in such a way that a worker who is standing at the level of the platform 22 may, with an upright posture, may use his or her hands to grip both the upper ladder 16 and the lower ladder 14. In the example shown, the height of the overlap region U may be approximately 1.40 m.

In the present case, the upper ladder 16may have a horizontal distance from the front side of the shoring panel 12. In order to realize a course of the upper ladder 16 that is as vertical as possible, two supporting feet 30 which extend in the horizontal direction and which support the lower end of the upper ladder 16 against the front side of the shoring panel 12 may be arranged at the lower end of the upper ladder 16. The length of the supporting feet 30 may be varied depending on the thickness of the shoring panel 12 or the distance of the upper ladder 16 from the shoring panel 12.

In addition, the upper ladder 16may have arranged thereon a climb-in aid 32 in the form of hand rails 34 which may be arranged at the right and left at the upper end of the upper ladder 16. The hand rails 34 may extend, as viewed from top to bottom, first horizontally and then vertically such that a worker may firmly hold thereon when climbing into and out of the trench.

Also arranged on the upper ladder 16 may be three back protection bows 36 which enclose the front side of the upper ladder 16 in the form of a ring segment and may be connected to one another by a plurality of vertically extending bars 38.

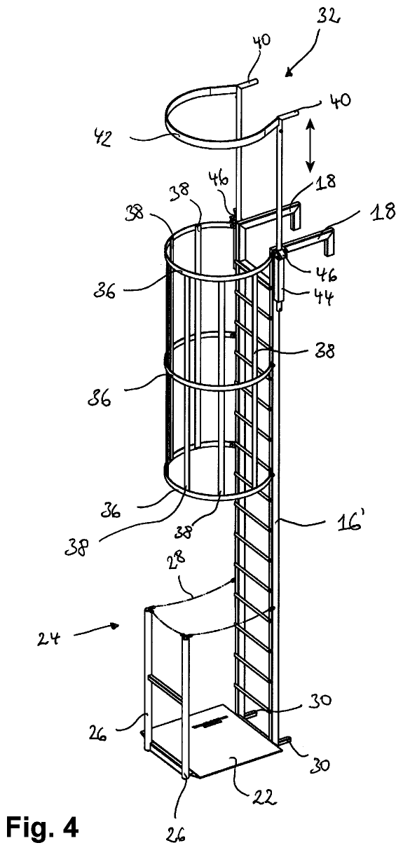

FIG. 4 shows a further variant of the upper ladder 16′. The same reference signs as for the description of the first variant may be used therein for identical or at least functionally identical components.

This upper ladder 16′ may likewise be used in conjunction with a lower ladder 14 in a ladder system 10, as is illustrated in FIGS. 1-3. The essential difference of the upper ladder 16′ shown in FIG. 4 is that the climb-in aid provided is a height-adjustable hand rail 40 may have a back protection bow 42 fastened thereto. The hand rail 40 may be height-adjustable with the back protection bow 42 in the direction of the double arrow. For this purpose, two sleeves 44 in which the hand rail 40 may be respectively received in a height-adjustable manner may be provided laterally of the upper ladder 16′. The hand rail 40 may be securely clamped at the intended height via a foot-actuatable clamping lever 46.

In this second variant of the upper ladder 16′ too, a platform 22 having a railing 24 may be arranged at the lower end. Also provided here, as in the variant of FIGS. 1-3, may be a plurality of positionally fixed back protection bows 36 which may be connected to one another via vertical bars 38.

The features of the system described herein that are disclosed in the present description, in the drawings and in the claims may be essential both individually and in any desired combinations for realizing the system described herein in its various embodiments. The invention is not limited to the embodiments described. It may be varied within the scope of the claims and with consideration to the knowledge of a person skilled in the relevant art. Other embodiments of the system described herein will be apparent to those skilled in the art from a consideration of the specification and/or an attempt to put into practice the system described herein disclosed herein. It is intended that the specification and examples be considered as illustrative only, with the true scope and spirit of the invention being indicated by the following claims

Attention is particularly also drawn to the possibility that the upper ladder 16 and the lower ladder may be connected to one another against slipping by means of a securing element.

For trenches having a relatively large depth, it is also possible to make available a ladder system 10 which has more than two ladders, in particular two upper suspension ladders in combination with a lowermost ladder which stands on the bottom of the trench.

1. A ladder system for trench shoring, comprising:
a lower ladder which extends from the bottom of a trench over a lower sub-portion of the height of the trench;
an upper ladder which extends over an upper sub-portion of the height of the trench up to a trench edge, wherein the upper ladder is a suspension ladder for suspending onto a shoring panel; and
a platform is arranged at the lower end of the upper ladder,
wherein the lower ladder is a stepladder or leaning ladder which stands on the bottom of the trench.

2. A ladder system according to claim 1, wherein the lower ladder and the upper ladder are arranged so as to be laterally offset with respect to one another, and
wherein the lower ladder and the upper ladder extend next to one another in an overlap region.

3. A ladder system according to claim 1, wherein at least one of the upper ladder and the lower ladder is height-adjustable.

4. A ladder system according to claim 1, wherein the platform has a peripheral railing.

5. A ladder system according to claim 1, wherein at least one supporting foot, which is supported against the trench wall, is arranged at the lower end of the upper ladder.

6. A ladder system according to claim 1, wherein a climb-in aid is arranged on the upper ladder.

7. A ladder system according to claim 1, wherein at least one back protection bow is arranged on the upper ladder.

8. A ladder system according to claim 7, wherein at least the uppermost back protection bow is height-adjustable with respect to the upper ladder.

9. A ladder system according to claim 1, wherein the lower ladder and the upper ladder are connected to one another via a securing element.

10. (canceled)

11. A method comprising:
providing a ladder system including:
a lower ladder which extends from the bottom of a trench over a lower sub-portion of the height of the trench, wherein the lower ladder is a stepladder or leaning ladder which stands on the bottom of the trench,
an upper ladder which extends over an upper sub-portion of the height of the trench up to a trench edge, wherein the upper ladder is a suspension ladder for suspending onto a shoring panel, and
a platform arranged at the lower end of the upper ladder; and shoring a trench using the ladder system.

12. A method according to claim 11, wherein the lower ladder and the upper ladder are arranged so as to be laterally offset with respect to one another, and
wherein the lower ladder and the upper ladder extend next to one another in an overlap region.

13. A method according to claim 11, wherein at least one of the upper ladder and the lower ladder is height-adjustable.

14. A method according to claim 1, wherein the platform has a peripheral railing.

15. A method according to claim 1, wherein at least one supporting foot, which is supported against the trench wall, is arranged at the lower end of the upper ladder.

16. A method according to claim 1, wherein a climb-in aid is arranged on the upper ladder.

17. A method according to claim 1, wherein at least one back protection bow is arranged on the upper ladder.

18. A method according to claim 7, wherein at least the uppermost back protection bow is height-adjustable with respect to the upper ladder.

19. A method according to claim 1, wherein the lower ladder and the upper ladder are connected to one another via a securing element.

20. A method of creating a ladder system for shoring a trench, comprising:
arranging a suspension ladder to extend over an upper sub-portion of the height of the trench up to a trench edge and to suspend onto a shoring panel;
arranging a platform at the lower end of the upper ladder; and
arranging a lower ladder to stand on the bottom of the trench and extend over a lower sub-portion of the height of the trench,
wherein the lower ladder is a stepladder or leaning ladder.
